(19) United States
(12) Patent Application Publication
(10) Pub. No.: US 2015/0054893 A1
(43) Pub. Date: Feb. 26, 2015

(54) METHOD FOR FORMING NON-ELECTRIC DISPLAY OBJECT

(71) Applicant: Toshiba Tec Kabushiki Kaisha, Tokyo (JP)

(72) Inventor: Keiichi Kikuchi, Kanagawa-ken (JP)

(73) Assignee: Toshiba Tec Kabushiki Kaisha, Tokyo (JP)

(21) Appl. No.: 13/973,089

(22) Filed: Aug. 22, 2013

(51) Int. Cl. B41J 2/21

(52) U.S. Cl. CPC B41J 2/2107
USPC 347/100

(57) ABSTRACT

A method for forming, by an ink-jet system, a print letter image that can be displayed without electricity even at night is provided. A method for forming a non-electric display object according to an embodiment includes ejecting a color ink-jet ink having a photoluminescent property onto a base member by an ink-jet system, and thus forming a photoluminescent color developing layer.

### FIELD

Embodiments described herein relate generally to a method for forming a non-electric display object.

### BACKGROUND

Recently, with rapid progress in image forming techniques using an ink-jet system, it is possible to output high-quality images comparable to photographic images. The ink-jet system enables an appropriate amount of ink to drip down accurately in a contactless manner at a predetermined position and therefore is increasingly used for various applications.

Along with applications, types of recording media and ink-jet inks are diversified and proper types are selected according to applications. For example, oil-based, UV-type, aqueous, and solvent ink-jet inks are known. Ink-jet image formation is an effective printing method to meet the requirement of print letter images in small amounts and various types.

The print letter images in small amounts and various types may be, for example, logo printing, business card printing, billboard and decorative lighting display printing, and the like. For decorative lighting displays according to the related art, for example, a print object provided on the face side of a semitransparent base member, and a light source arranged on the back side of the semitransparent base member are used (see JP-A-2003-305941). The print object is provided by forming a print letter image directly on the face side of the base member by printing directly or painting, or by bonding a separately prepared print letter image onto the face side of the base member. Such a print letter image is irradiated with light from the back side of the base member, thus displaying the print letter image. Particularly, in order to display the print letter image at night, electric power is necessary for the light source to emit light.

### DESCRIPTION OF THE DRAWINGS

FIG. 1 is a sectional view showing a method for forming a non-electric display object according to an embodiment.

FIG. 2 is a schematic view showing the configuration of a non-electric display object formed by a method according to another embodiment.

FIGS. 3A and 3B are sectional views showing a process of forming a non-electric display object according to another embodiment.

FIG. 4 is a schematic view showing the configuration of a non-electric display object formed by a method according to another embodiment.

FIG. 5 is a schematic view showing the configuration of a non-electric display object formed by a method according to an embodiment.

FIG. 6 is a schematic view showing the configuration of a decorative lighting display object according to the related art.

### DETAILED DESCRIPTION

In general, according to one embodiment, a method for forming, by an ink-jet system, a print letter image that can be displayed without electricity even at night is provided.

A method for forming a non-electric display object according to an embodiment includes ejecting a color ink-jet ink having a photoluminescent property onto a base member by an ink-jet system and thus forming a photoluminescent color developing layer.

Hereinafter, specific embodiments will be described with reference to the drawings.

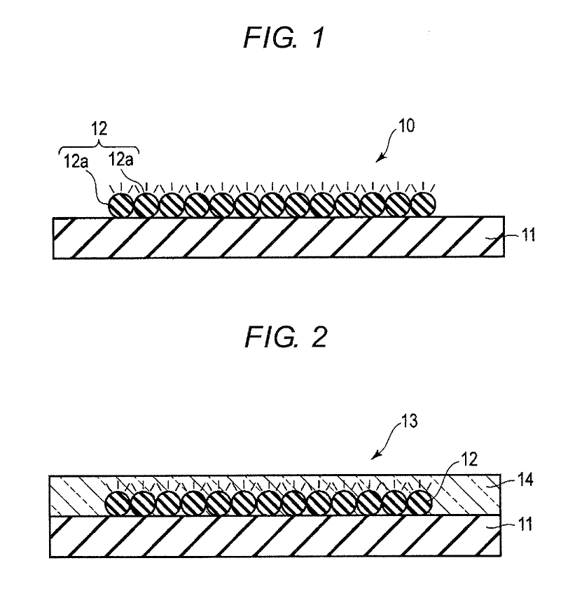

FIG. 1 shows a method for forming a non-electric display object according to an embodiment. In the forming method according to the embodiment, a photoluminescent ink layer 12 including a color ink-jet ink having a photoluminescent property (hereinafter referred to as a photoluminescent ink-jet ink) is formed on a base member 11, thus providing a non-electric display object 10, as shown in FIG. 1. The photoluminescent ink layer 12 includes plural ink dots 12a and can form, for example, a letter or image.

The base member 11 can be made of any material on which an ink layer can be formed using an ink-jet ink. For example, a resin material such as polyester and polyethylene, a cloth material, a wooden board material, a metal material or the like can be used as the base member 11.

On the base member 11, a photoluminescent ink-jet ink is ejected by an ink-jet method, thus forming the photoluminescent ink layer 12. Since the photoluminescent ink-jet ink that is used contains a photoluminescent pigment, photoluminescence and color development take place in the resulting photoluminescent ink layer 12. The photoluminescent ink layer 12 can be called a photoluminescent color developing layer.

The photoluminescent pigment is a substance having a long-term afterglow property. That is, the photoluminescent pigment can absorb and store light energy and voluntarily emit the energy in the form of light with a predetermined wavelength. Moreover, the photoluminescent pigment can repeat the process of absorbing and storing energy and emitting light many times. The wavelength of the emitted light is decided by the type of the photoluminescent pigment.

Photoluminescent pigments that can be used may be compounds, for example, SrAl₂O₄:Eu, SrAl₂O₄:Eu, Dy, Sr₄Al₁₂O₂₅:Eu,Dy, or CaAl₂O₄:Eu,Nd.

Since the photoluminescent pigment is used in the ink-jet ink, it is preferable that the average particle diameter of the photoluminescent pigment is within a range of approximately 0.01 to 10 μm. It is more preferable that the average particle diameter of the photoluminescent pigment is within a range of approximately 0.01 to 5 μm. The average particle diameter of the photoluminescent pigment can be measured with a particle size analyzer using dynamic light scattering. As the particle size analyzer, for example, HPPS (Malvern Instruments Ltd.) can be employed.

The photoluminescent pigment can be dispersed in a predetermined dispersion medium, thus forming a photoluminescent ink-jet ink. As the dispersion medium, for example, water, ethanol, alcohol such as oleyl alcohol, and oil and fat such as triglyceride can be used. Also, by using a dispersion assisting agent as well, dispersion stability of the photoluminescent pigment in the ink-jet ink can be increased. Moreover, if UV-curable resin is contained therein, ultraviolet rays can be cast to cure the ink layer. The UV-curable resin may be, for example, acrylic acid oligomer, acrylic acid monomer or the like. It is desirable that the UV-curable resin is used together with a UV polymerization initiator and sensitizer, as normally known. Also, if a binder resin is contained in the ink-jet ink, contactability between the resulting photoluminescent ink layer 12 and the base member 11 can be increased.

The amount of the photoluminescent pigment in the photoluminescent ink-jet ink can be set properly according to the photoluminescent performance thereof or the like.

An example of prescription of a UV-curable photoluminescent ink-jet ink is shown below.

| Photoluminescent pigment | 15 parts by weight |
|---|---|
| Binder resin | 10 parts by weight |
| Acrylic acid oligomer | 15 parts by weight |
| Acrylic acid monomer | 45 parts by weight |
| UV polymerization initiator and sensitizer | |
| | 10 parts by weight |
| Dispersion assisting agent | 5 parts by weight |

The type and amount of the UV-curable resin is not limited to the above. Any UV-curable resin that is normally used in UV-curable ink-jet inks can be used in an amount that is normally used. Similarly, components such as binder resin, UV polymerization initiator and sensitizer, and dispersion assisting agent are not particularly limited. Any material that is normally used in UV-curable ink-jet inks can be used in an amount that is normally used.

A non-photoluminescent pigment used in normal ink-jet inks can be used as well within a range that does not impair the photoluminescent effect.

Since the ink prepared in the composition as described above is used as an ink-jet ink, it is desirable that this ink has a viscosity of approximately 5 to 30 mPa·s at 25° C.

The photoluminescent ink-jet ink is ejected onto the base member 11 from a nozzle of an ink-jet head by a normal method and cured by light irradiation or heating. Thus, the photoluminescent ink layer 12 can be formed. Since the photoluminescent pigment is contained in the ink as described above, the photoluminescent ink layer 12 acts by itself as a photoluminescent color developing layer. That is, when light is cast thereon (bright), the energy of the light is absorbed and stored in the photoluminescent ink layer 12. After that, when there is no light irradiation (dark), the energy absorbed and stored in the photoluminescent ink layer 12 is emitted in the form of light with a predetermined wavelength. Thus, even when it is dark, color can develop to display letters and the like.

According to the forming method of at least one embodiment described above, by ejecting an ink-jet ink having a photoluminescent property onto a base member by an ink-jet system and thus forming a photoluminescent color developing layer, it is possible to provide a display object that can be recognized at night even without providing an electric light source.

On the photoluminescent ink layer 12, a transparent protection layer 14 may be provided, as shown in FIG. 2. The transparent protection layer 14 can be made of any material that has light resistance and weatherability and does not prevent light emission from the photoluminescent ink layer 12. For example, by applying a colorless, transparent ink onto the photoluminescent ink layer 12 by an ink-jet method and then drying the ink by a normal method, the transparent protection layer 14 can be formed. An ink that can be used may be, for example, an ink prepared in a similar manner to the foregoing ink, except for not containing a pigment. Alternatively, the transparent protection layer 14 may be provided by bonding a transparent film made of polyethylene terephthalate or the like. Since the photoluminescent ink layer 12 is protected, restrictions on the position of installation of such a non-electric display object 13 are eased.

The thickness of the transparent protection layer 14 is not particularly limited as long as the transparent protection layer 14 can cover the photoluminescent ink layer 12. In order to achieve target effects without causing any inconvenience, it is desirable that the thickness of the transparent protection layer 14 is approximately 1 to 100 μm.

In the above example, photoluminescence and color development take place in the single-layer photoluminescent color developing layer. However, photoluminescence and color development may take place in separate layers. For example, this can be achieved by forming a layer that functions for color development on a layer that functions for photoluminescence.

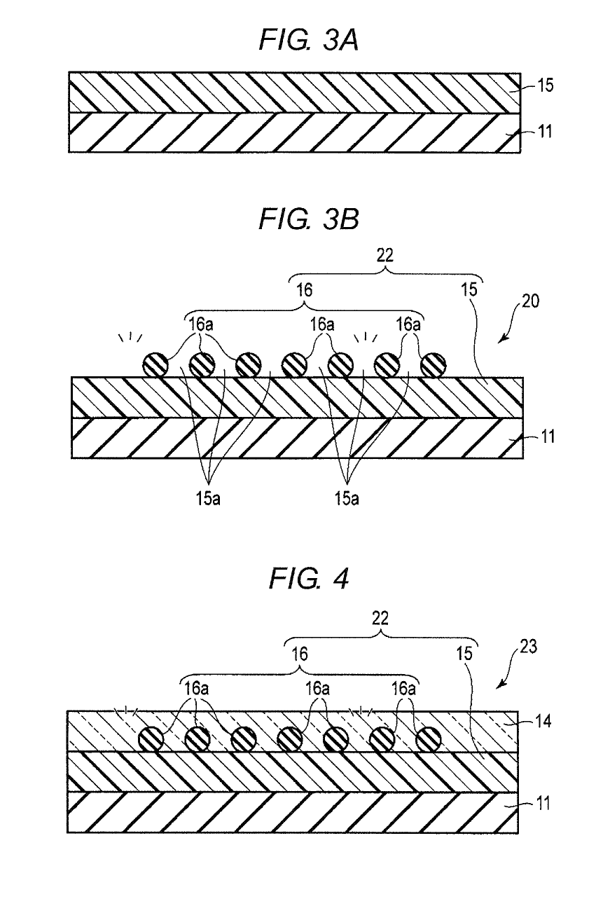

Referring to FIGS. 3A and 3B, a method for forming a non-electric display object having such a photoluminescent color developing layer will be described. First, as shown in FIG. 3A, a photoluminescent layer 15 is formed on a base member 11. The base member 11 can be made of any material on which an ink can be printed, as described above.

The photoluminescent layer 15 can be formed using a compound containing a photoluminescent pigment (photoluminescent layer material). The photoluminescent layer material is formed, for example, containing a photoluminescent pigment and a binder resin into a dispersion medium. As the dispersion medium, a solvent or water can be selected. As components that are contained therein, the foregoing components can be used. As already described, the use of the dispersant enables increase in dispersion stability of the photoluminescent pigment.

While the amount of each component contained in the photoluminescent layer material is not particularly limited, for example, the photoluminescent pigment can be contained at 5 to 30 parts by weight and the binder resin can be contained at 0.1 to 30 parts by weight.

The photoluminescent pigment is applied onto the base member 11 to form a coating, using gravure printing, offset printing, barcode printing, a screen system or the like, and after the application, the coating is dried with a drying furnace or the like. The photoluminescent layer 15 is thus formed. If the photoluminescent pigment contained therein has an appropriate particle diameter, the photoluminescent layer 15 can be formed by an ink-jet system. The thickness of the photoluminescent layer 15 is properly selected according to the amount of the photoluminescent pigment contained therein and the like and can be thinner as the amount of the pigment is greater. If the photoluminescent layer 15 has a thickness of approximately 10 to 200 μm, target effects can be achieved without any inconvenience.

A color ink-jet ink is ejected on the photoluminescent layer 15 and a color ink layer 16 is formed, as shown in FIG. 3B. Thus, a non-electric display object 20 is provided. The color ink layer 16 can form, for example, a letter, image or the like. A proper combination of colors of a coloring material contained in the color ink layer 16 can be selected according to purpose.

The color ink layer 16 includes plural ink dots 16a. It is preferable that the ink dots 16a arranged on the photoluminescent layer 15 are arranged next to each other at intervals as shown in FIG. 3B so that exposed areas 15a exist on the photoluminescent layer 15. When light is cast thereon (bright), the exposed areas 15a on the photoluminescent layer 15 absorb and store light energy. When there is no light irradiation (dark), the exposed areas 15a can emit light. With the light emitted from the exposed areas 15a on the photoluminescent layer 15, the letter or the like formed by the color ink layer 16 is displayed. That is, photoluminescence takes place in the photoluminescent layer 15, and even when it is dark, the letter or the like can be displayed through color development in the color ink layer 16.

If the exposed areas 15a between the ink dots 16a become greater, the foregoing photoluminescent effect of the photoluminescent layer 15 is enhanced, but there is a risk of a fall in image quality of the letter or the like formed by the color ink layer 16. If the size of the exposed areas 15a existing between the ink dots 16a that are next to each other is approximately ⅓ of the dot diameter or greater and 1 μm or greater, target effects can be achieved without causing inconvenience. Generally, the diameter of the ink dots 16a is approximately 30 to 120 μm. The dot diameter of the ink dots 16a and the size of the exposed areas 15a existing between the ink dots 16a that are next to each other can be controlled, for example, by the number of drops ejected, applied voltage and the like.

As the color ink-jet ink used to form the color ink layer 16, a solvent ink or UV-curable ink is selected. A solvent ink contains an organic solvent or oil and fat. A UV-curable ink contains a UV-curable resin. Compared with an aqueous ink containing water, a solvent or UV-curable ink-jet ink is advantageous in fixability onto the print surface.

Such an ink can be prepared, for example, by combining an organic pigment or inorganic pigment as a coloring material and a component that is normally used in ink-jet pigment inks, in amounts that are normally used. Since the ink is used as an ink-jet ink, as described above, it is desirable that the ink prepared in the above composition has a viscosity of approximately 5 to 30 mPa·s at 25° C.

The solvent ink can be prepared, for example, by mixing 20 parts by weight of pigment, 20 parts by weight of binder resin, 45 parts by weight of solvent, 10 parts by weight of drying oil, and 5 parts by weight of dispersion assisting agent. As the solvent, for example, N-methylpyrrolidone or the like can be used, and fat and oil can be used. The drying oil can be, for example, linseed oil or the like. Also, the solvent ink may contain fat and oil such as octyl oleate.

The UV-curable ink can be prepared, for example, by mixing 15 parts by weight of pigment, 10 parts by weight of binder resin, 15 parts by weight of acrylic acid oligomer, 45 parts by weight of acrylic acid monomer, 10 parts by weight of UV polymerization initiator and sensitizer, and 5 parts by weight of dispersion assisting agent. The UV-curable ink may contain water, alcohol, fat and oil or the like.

Also, a dye can be used as the coloring material. In this case, the dispersion assisting agent need not be contained. As the dye, any material used in normal ink-jet dye inks may be used in an amount that is normally used.

The coating formed by ejecting the solvent color ink-jet ink onto the photoluminescent layer 15 is cured, for example, by heat drying, and thus provides the color ink layer 16. Meanwhile, the coating formed by ejecting the UV-curable color ink-jet ink is cured by irradiation with UV rays and thus provides the color ink layer 16.

The photoluminescent layer 15 containing the photoluminescent pigment and the color ink layer 16 provided on the photoluminescent layer 15 form a photoluminescent color developing layer 22. As already described, the photoluminescent layer 15 is exposed between the ink dots 16a forming the color ink layer 16. When light is cast thereon (bright), the energy of the light is absorbed and stored in the photoluminescent layer 15 in the exposed areas. After that, when there is no light irradiation (dark), the energy that is absorbed and stored is emitted as light, thereby allowing the display on the color ink layer 16 to be recognized.

According to the forming method of the above embodiment, by ejecting the color ink-jet ink by an ink-jet system onto the photoluminescent layer 15 provided on the base member and thus forming the photoluminescent color developing layer 22 including a multilayer structure with the photoluminescent layer 15 and the color ink layer 16, it is possible to provide a display object that can be recognized at night even without providing an electric light source.

A transparent protection layer 14 as shown in FIG. 4 may be provided on the photoluminescent color developing layer 22. The transparent protection layer 14 can be formed by the above technique. Restrictions on the installation position of such a non-electric display object 23 are eased.

Here, a non-electric display object formed by a method according to one embodiment and a decorative lighting display object according to the related art are compared, referring to the drawings.

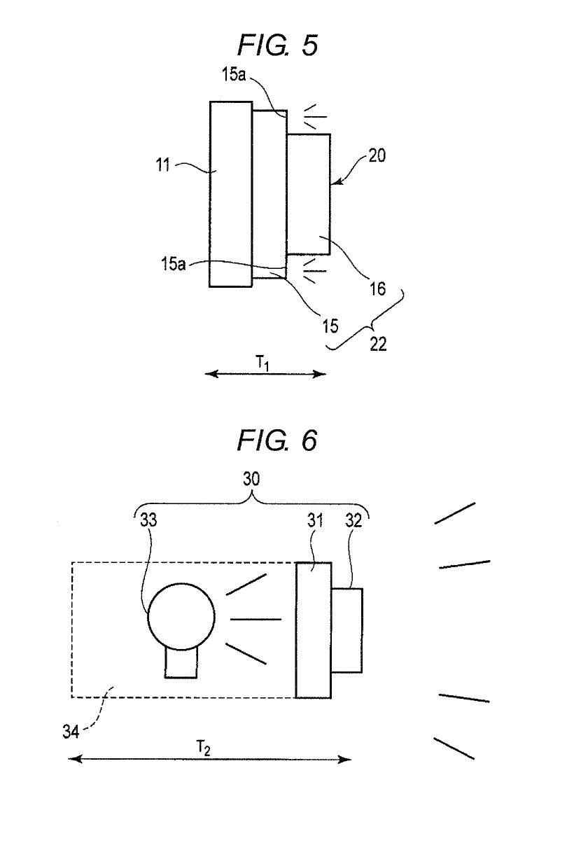

As shown in the schematic view of FIG. 5, a non-electric display object 20 formed by a method according to one embodiment includes a base member 11, and a photoluminescent color developing layer 22 including a photoluminescent layer 15 and a color ink layer 16. Light is emitted from exposed areas 15a on the photoluminescent layer 15, thus showing a display. Since the display is shown without using electricity, no light source is needed and there is no need to provide an area where a light source is arranged. The thickness T₁ of the non-electric display object 20 can be restrained to the total of the thickness of the base member 11, the thickness of the photoluminescent layer 15, and the thickness of the color ink layer 16.

Meanwhile, as shown in FIG. 6, in a decorative lighting display object 30 according to the related art, a print letter image 32 is provided on the face side of a semitransparent base member 31 and a light source 33 is arranged on the back side of the semitransparent base member 31. Light emitted from the light source 33 is transmitted through the semitransparent base member 31 and thus shows the display of the print letter image 32. In addition to the need for the light source 33 that uses electricity, an area 34 where this light source 33 is arranged must be secured. The thickness T₂ of the decorative lighting display object 30 includes the thickness of the area 34 where the light source 33 is arranged, in addition to the thickness of the semitransparent base member 31 and the thickness of the print object 32.

The non-electric display object formed by the method according to this embodiment is also advantageous in reduction in thickness.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A method for forming a non-electric display object, comprising ejecting a color ink-jet ink having a photoluminescent property onto a base member by an ink-jet system and thus forming a photoluminescent color developing layer.

2. A method for forming a non-electric display object, comprising forming a photoluminescent color developing layer on a base member by an ink-jet system.

3. The method according to claim 2, wherein the photoluminescent color developing layer is formed by forming a photoluminescent layer on the base member, then ejecting a solvent or UV-curable color ink-jet ink by an ink-jet method and thus providing a color ink layer including plural ink dots.

4. The method according to claim 3, wherein the color ink-jet ink is ejected in such a way that the ink dots are arranged next to each other at an interval equal to or greater than ⅓ of a diameter of the ink dots.

5. The method according to any one of claim 1, further comprising forming a transparent protection layer on the photoluminescent color developing layer.

6. The method according to any one of claim 2, further comprising forming a transparent protection layer on the photoluminescent color developing layer.

7. The method according to any one of claim 3, further comprising forming a transparent protection layer on the photoluminescent color developing layer.

8. The method according to any one of claim 4, further comprising forming a transparent protection layer on the photoluminescent color developing layer.
